(19) United States
(12) Patent Application Publication
(10) Pub. No.: US 2021/0379806 A1
(43) Pub. Date: Dec. 9, 2021

(54) MOLD FOR INJECTION MOLDING PROCESSES AND MOLDING PROCESS USING THE MOLD

(71) Applicant: SMART MOLD S.R.L., CITTADELLA (IT)

(72) Inventors: Giovanni LUCCHETTA, SCHIO (IT); Davide MASATO, PIANIGA (IT); Marco SORGATO, VIGONZA (IT)

(73) Assignee: SMART MOLD S.R.L., CITTADELLA (IT)

(21) Appl. No.: 16/962,913

(22) PCT Filed: Jan. 14, 2019
(86) PCT No.: PCT/EP2019/050818

§ 371 Date: Jul. 17, 2020

(30) Foreign Application Priority Data
Jan. 19, 2018 (IT) 102018000001348

(51) Int. Cl. B29C 45/37; B29C 45/73; B29C 33/56

(52) U.S. Cl. CPC B29C 45/37; B29C 2033/422; B29C 33/56; B29C 45/73

(57) ABSTRACT

A mold for injection molding processes and a molding process that uses the mold. The mold has, at at least one part of the surface of its cavity raised portions which are longitudinally extended, are arranged side by side and are oriented substantially in the direction of the flow of the melted plastic material that is injected. During the process, the surface of the cavity of the mold is kept at a temperature that is lower than the glass transition temperature, in the case of molding of plastic material constituted by amorphous polymers, and lower than the crystallization temperature, in the case of molding of plastic material constituted by semicrystalline polymers.

The present invention relates to a mold for injection molding processes and to a molding process that uses said mold.

Injection molding, in which plastic material is melted and injected at high pressure into a closed metallic mold, which is opened after the hardening of the article in order to proceed with its extraction, is by now widespread in industrial production processes.

In order to ensure high productivity, in normal industrial practice the plastic material is cooled rapidly, keeping the mold at a temperature far lower than the melting point. The difference between the injection temperature of the melted polymer and the temperature of the mold is normally approximately 200° C.

For example, in the case of ABS (acrylonitrile-butadiene-styrene) molding, the injection temperature of the melted polymer is typically comprised between 200° C. and 280° C., while the temperature at which the mold is typically kept is comprised between 25° C. and 80° C.

Also by way of example, for PET (polyethylene terephthalate) the injection temperature of the melted polymer is typically comprised between 260° C. and 290° C., while the temperature at which the mold is kept is comprised between 15° C. and 120° C.

The high injection pressure is required in order to fill the mold, due to the viscosity of thermoplastic polymers, the low thickness of the cavity and the low temperature of the mold. For example, a molding application with a thin wall, less than 1 mm, can require a molding press with 200 MPa of available injection pressure.

The need is particularly felt, in the sector, to reduce this pressure, with the prospect of energy saving and in favor of a reduction of overall production costs.

As is known in the literature, a significant reduction of the injection pressure can be achieved by inducing the flow of the polymeric melted material on the surface of the cavity of the mold, which occurs within the first monolayer of macromolecular chains that are adsorbed to the mold wall.

One currently known solution is constituted by coatings of the molding cavity with low surface energy, for example organic coatings such as PTFE (polytetrafluoroethylene). These coatings are able to suppress polymer adsorption and promote flow, but have a limited lifespan.

Laser ablation processes are also known in order to modify the roughness of the contact surface of the polymeric material, but in studies conducted on micro/nanostructured surfaces obtained by laser ablation a reduction of the flow of the polymer to the wall and a consequent increase of the injection pressure have been observed.

An important exception is constituted by WO 2012/128969 A1, which describes a system with hot channels in which the surfaces for contact with the polymeric material have a hierarchical structure, imitating the micro/nanostructure of lotus leaves, which are characterized by high hydrophobicity, caused by a surface microstructure with microscopic raised portions and with wax crystals present on these raised portions.

According to the teachings contained in the above document, a first level of hierarchical microstructure can be achieved with a material removal process, for example by chemical etching or by laser ablation, or with a material deposition process or with a coating. The second level of hierarchical microstructure can be provided with a process for the addition of material or modification of the surface, in order to obtain a surface with low surface energy or with repellent capabilities with respect to the melted polymer, imitating the wax crystals that are present on lotus leaves.

The hierarchical structure thus obtained induces the flow of the material on the surface of the hot channels, causing a consequent reduction of the injection pressure. As is known for a person skilled in the art, the expression “hot channel system” is understood to reference a set of heated components (typically it includes a manifold and a certain number of nozzles) used in injection molds in order to transfer the plastic material in the melted state from the plasticizing cylinder to the cavity of the mold, preventing its cooling. The surfaces of the hot channels are therefore conveniently kept at a temperature that is close to the injection temperature of the melted material, therefore approximately 200° C. higher than the temperature of the mold.

The cited document therefore teaches how to obtain a surface structure that is capable of inducing the flow of the material in the hot channels, but is difficult to apply to the mold, due to the need to keep the latter at a temperature that is distinctly lower than the channels.

Methods for the treatment of the surfaces to provide periodic nanostructures are also known, including photolithography, electron-beam lithography, Nonlinear Laser Lithography (NLL), etc. The latter, differently from the other known methods, is potentially cheaper and offers greater flexibility.

This treatment is known in the field as Laser-Induced Periodic Surface Structures (LIPSS).

LIPSS typically emerge as a surface raised portion composed of almost periodic nanometer lines, which show a correlation with the wavelength and polarization of the radiation. This can occur over a wide range of pulses, from continuous wave radiation to a few femtoseconds.

Substantially, in the field the expression “periodic structures” is understood to reference structures that have ripples, undulations generated by ridges and hollows arranged side by side. The periodicity consists substantially in the almost identical repetition of the single wave.

Currently, the production of periodic surface nanostructures by means of NLL is applied to reduce the friction coefficient, increase wear resistance, improve flow in narrow interstices for oil-pressure controlled applications, functionalize surfaces (for example by rendering them hydrophobic), etc.

The nanotexturing on a mold is in fact replicated on the molded components and this allows to functionalize the surface of the molded plastic component or to obtain particular decorative effects, such as reflective effects which generate shifting colors and reflections, which are a function of the direction of the texturing and of the incidence of the light.

In order to transfer the nanotexture from the mold, said mold must be kept at a high temperature during the injection and compaction steps of the molding process. In particular, the nanostructured surface must be kept at a temperature that is higher than the glass transition temperature for amorphous polymers and higher than the crystallization temperature for semicrystalline polymers. The higher the temperature of the mold, the better the replication.

As anticipated, instead, in normal industrial practice it is necessary to keep the temperature of the mold far lower, in order to ensure high productivity.

The aim of the present invention is to provide a mold for injection molding processes that is capable of improving the background art in one or more of the aspects indicated above.

Within this aim, an object of the invention is to provide a mold and a molding method by means of which to reduce the injection pressure in plastic material molding processes.

Another object of the invention is to provide a mold that is capable of facilitating the flow of the polymers during molding.

A further object of the invention is to obtain a mold with low surface adsorption by means of known methods for treating the surface at the micro-nanometer level.

A still further object of the present invention is to overcome the drawbacks of the background art in a manner that is alternative to any existing solutions.

Another object of the invention is to provide a mold that is highly reliable, relatively simple to provide and at competitive costs.

This aim, as well as these and other objects which will become better apparent hereinafter, are achieved by a mold for injection molding processes, characterized in that it has, at at least one part of the surface of its cavity, raised portions which are longitudinally extended, are arranged side by side and are oriented substantially in the direction of a flow of the melted plastic material that is injected.

Further characteristics and advantages of the invention will become better apparent from the description of a preferred but not exclusive embodiment of the mold according to the invention, illustrated by way of nonlimiting example, in the accompanying drawings, wherein:

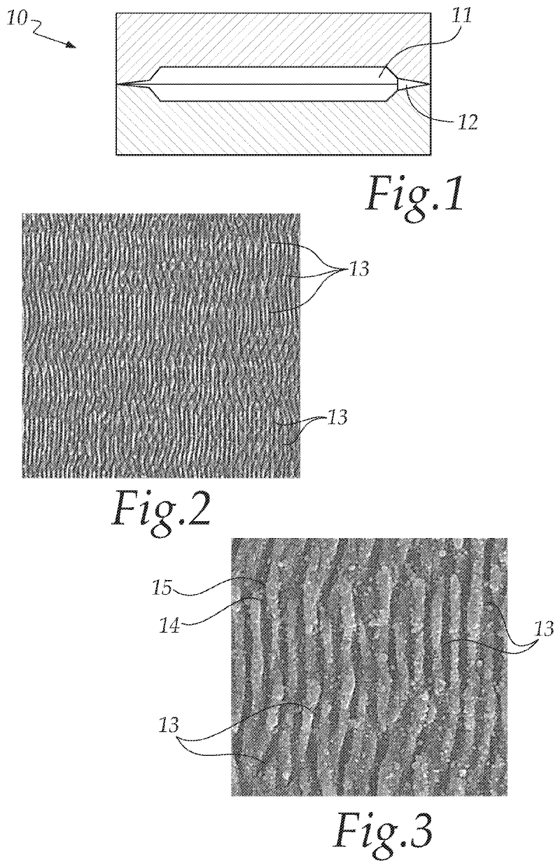

FIG. 1 is a sectional view of a mold;

FIG. 2 is an enlarged-scale view of a surface nanostructure of a mold according to the invention;

FIG. 3 is another enlarged-scale view of the nanostructure shown in FIG. 2;

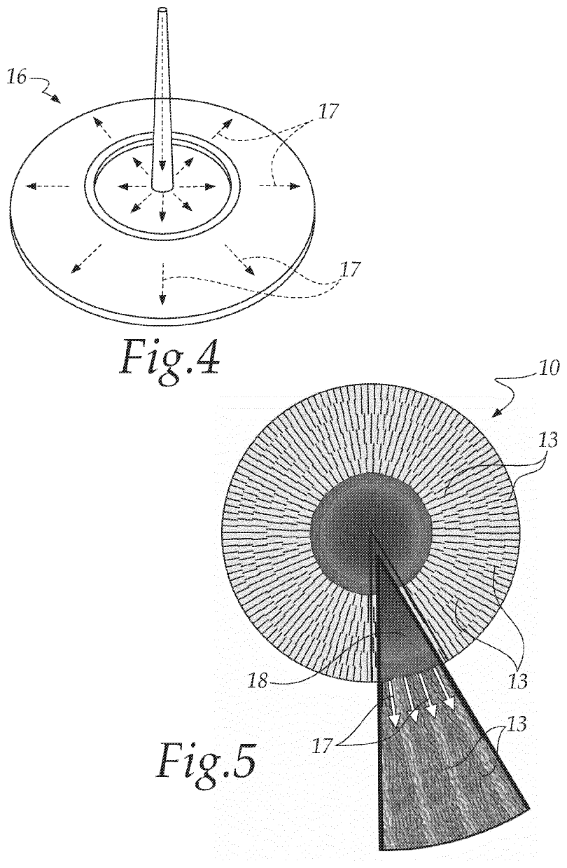

FIG. 4 is a view of a first example of a molded object;

FIG. 5 is a view of the structure of the surface of the mold according to the invention, used in the molding of the object according to FIG. 4;

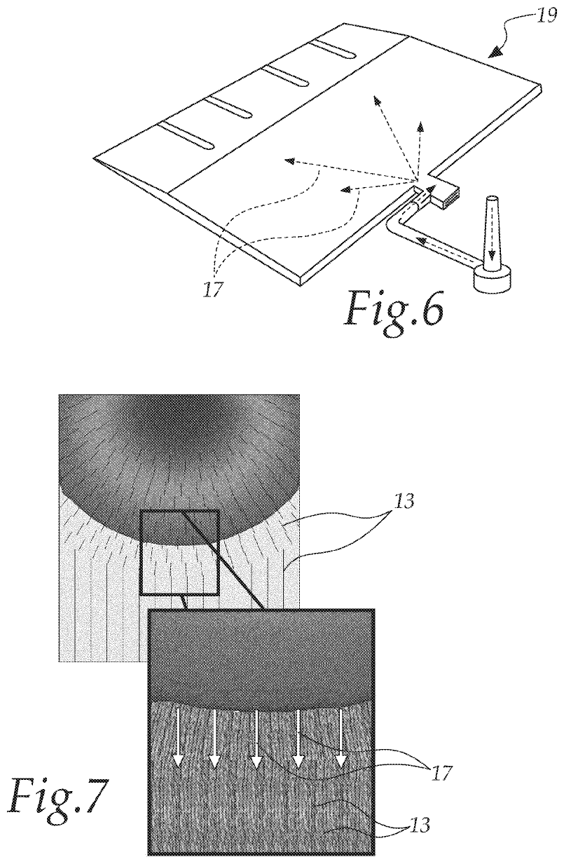

FIG. 6 is a view of a second example of a molded object;

FIG. 7 is a view of the structure of the surface of the mold according to the invention, used in the molding of the object according to FIG. 6;

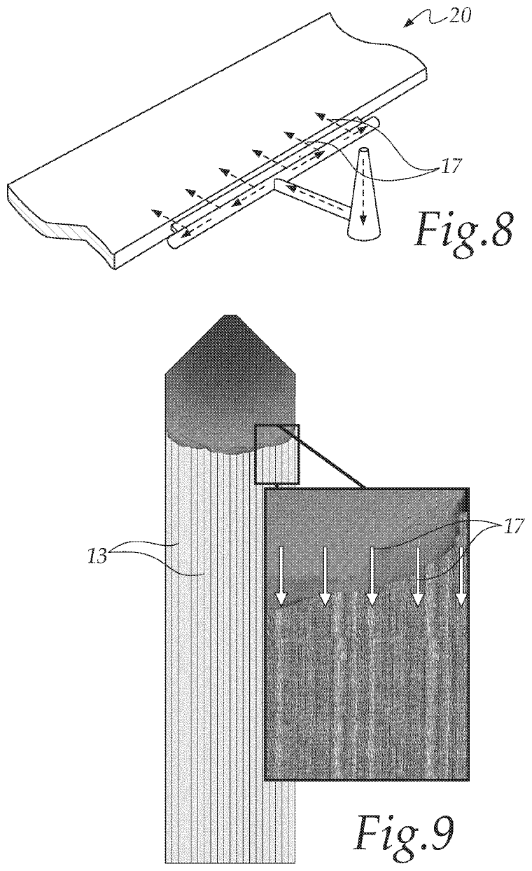

FIG. 8 is a view of a third example of a molded object;

FIG. 9 is a view of the structure of the surface of the mold according to the invention, used in the molding of the object according to FIG. 8.

With reference to the figures, the mold according to the invention is designated generally by the reference numeral 10.

A mold 10 is shown in cross-section in FIG. 1, in which a cavity 11, to be filled with the thermoplastic material and which, with its impression, gives shape to the object to be produced, and a sprue 12, at the injection point, are indicated.

As can be seen from the enlarged-scale views of FIG. 2 and FIG. 3, photographed on the surface of the cavity of the mold 10, said mold has, at at least one part of the surface of its cavity 11, raised portions 13 which are longitudinally extended, are arranged side by side and are oriented substantially in the direction of the flow of the melted (thermoplastic) plastic material that is injected.

It is evident that the raised portions 13 consist of undulations formed by an alternation of ridges 14 and hollows 15, which are indicated in FIG. 3.

Preferably, each one of the undulations has a width and a wavelength of less than 1 μm.

The geometric structure is in fact repeated almost identically at regular intervals of less than 1 μm.

The raised portions 13, therefore the undulations, are provided by laser ablation of the surface of the mold 10 so as to obtain a periodic nanostructure, where the term “periodic” is understood to reference the almost identical repetition of the single undulation. This treatment is known in the field as LIPSS (Laser-Induced Periodic Surface Structures) and can be obtained by means of known methods for laser ablation of the surface, with femtosecond sources. In particular, NLL (Non-linear Laser Lithography) is the technology to be preferred, since it allows higher productivity.

The mold 10 according to the invention is preferably made of steel.

As an alternative, it can be made of aluminum or coated steel, the coating being obtained with a process selected preferably from chromium plating, nickel plating, physical vapor deposition (PVD) and chemical vapor deposition (CVD). Moreover and as an alternative, the mold 10 can be made of steel treated by means of a process chosen from hardening, nitriding, cementing and oxidation.

These coatings and treatments, as is known, increase the hardness of the surface of the cavity and consequently its wear resistance. Laser treatments, adapted to obtain a periodic nanostructure, only modify the topography of the surface without altering its mechanical properties and are therefore compatible both with coatings and with treatments.

The raised portions 13, in addition to being arranged side by side, are repeated in the direction at right angles to the flow of the plastic material.

Substantially, the orientation of the raised portions 13 (and therefore of the undulations), which as mentioned have a longitudinal extension, is parallel to the direction of the flow of the polymer, i.e., to the direction of advancement in the mold from the injection point.

This concept is explained in the illustrations in FIGS. 4 to 9, with three examples of molded objects and corresponding nanostructures of the mold.

In particular, FIG. 4 shows a disk-like product 16, with the sprue at the center, which corresponds to the region where injection occurs.

The arrows indicated by 17 indicate the radial direction of the filling flow.

As a function of the radial flow direction, the orientation of the nanostructure to be obtained on the surface of the cavity 11 of the mold 10 is the one shown schematically in FIG. 5, which also shows an enlarged-scale microscope view of a part of said structure. This orientation is also correspondingly radial, with a number of raised portions 13 that is conveniently larger for greater distances from the center.

The same FIG. 5 also indicates the flow front of the polymer, with the reference numeral 18, where the flow substantially passes from the injection direction to the radial direction for filling the cavity, and the numeral 17 designates the arrows that represent the filling flow beyond the front 18.

FIG. 6 provides as an example a product 19 that is rectangular in plan view, with the direction of the filling flow indicated by the arrows 17 which move radially away from a point of one side of the product.

The direction of the flow corresponds to the orientation of the nanostructure as shown schematically in the FIG. 7.

The orientation is mixed, i.e., the raised portions are arranged radially close to the injection region and are then mutually parallel.

FIG. 8 is a view of an example of a product 20 in which the filling flow, designated again by 17, is unidirectional since it is distributed in a parallel manner from multiple points.

Correspondingly, the orientation of the raised portions 13 of the nanostructure is unidirectional, as shown in the subsequent FIG. 9.

The temperature of the internal surface of the mold 10 during injection is lower than the glass transition temperature, in the case of molding of plastic material constituted by amorphous polymers, and lower than the crystallization temperature, in the case of molding of plastic material constituted by semicrystalline polymers.

The present invention also relates to an injection molding process, in which a mold 10 is used, wherein the surface of the cavity is kept at a temperature that is lower than the glass transition temperature, in the case of molding of plastic material constituted by amorphous polymers, and lower than the crystallization temperature, in the case of molding of plastic material constituted by semicrystalline polymers.

Periodic surface nanostructures of the described type induce the flow of the polymers in the melted state at the mold wall and therefore allow significant reductions of the injection pressure. This is due substantially to the orientation of the nanostructure, therefore of the raised portions 13 and accordingly of the undulations, with respect to the direction of advancement of the flow of plastic material, i.e., with respect to the direction of advancement in the mold with respect to the injection point. The adsorption properties of the surface of the mold are reduced, facilitating the flow of the melted plastic material.

Laser ablation is used to modify the surface nanostructure of the mold, providing periodic undulations arranged parallel to the direction of advancement of the flow of plastic material, which depends on the impression of the mold and on the position of the injector with respect to said mold.

Tests performed in laboratory have verified that the wall flow speed of the melted plastic material depends not only on the orientation of the undulations but also increases as the temperature of the surface of the mold decreases. It is preferable to keep the nanostructured surface of the mold at the lowest possible temperature, to the extent allowed by the processability of the material.

In practice it has been found that the invention achieves the intended aim and objects, providing a mold and proposing a molding process by virtue of which it is possible to reduce the injection pressure in molding processes, facilitating the flow of the melted plastic material in said mold, at the same time keeping the temperature of the mold lower than the injection temperature of the melted plastic material, to the benefit of higher productivity.

It should also be noted that the reduction of the filling pressure facilitates the production of parts made of plastic material that are thinner than currently possible, with a consequent reduction of the consumption of materials and power and therefore also of production costs and environmental impact.

The invention thus conceived is susceptible of numerous modifications and variations, all of which are within the scope of the appended claims; all the details may furthermore be replaced with other technically equivalent elements.

In practice, the materials used, so long as they are compatible with the specific use, as well as the contingent shapes and dimensions, may be any according to the requirements and the state of the art.

The disclosures in Italian Patent Application No. 102018000001348 from which this application claims priority are incorporated herein by reference.

1.-9. (canceled)

10. A mold for injection molding processes, having mold cavity and comprising, at least one part of a surface of said cavity, raised portions which are longitudinally extended, are arranged side by side and are oriented substantially in a direction of a flow of a melted plastic material that is injected.

11. The mold according to claim 10, wherein said raised portions consist of undulations formed by an alternation of ridges and hollows.

12. The mold according to claim 10, wherein said raised portions are repeated in a direction at right angles to the flow of the melted plastic material.

13. The mold according to claim 10, wherein said raised portions are provided by laser ablation of the surface so as to obtain a periodic nanostructure.

14. The mold according to claim 11, wherein each one of said undulations has a width and wavelength of less than 1 μm.

15. The mold according to claim 10, wherein it is made of steel.

16. The mold according to claim 10, wherein it is made of coated steel, the coating being obtained by means of a process selected among chromium plating, nickel plating, physical vapor deposition (PVD) and chemical vapor deposition (CVD).

17. The mold according to claim 10, wherein it is made of steel treated by means of a process chosen from hardening, nitriding, cementing and oxidation.

18. An injection molding process, using a mold according to claim 10, wherein the surface of the cavity is kept at a temperature that is lower than a glass transition temperature, in the case of molding of plastic material constituted by amorphous polymers, and lower than a crystallization temperature, in the case of molding of plastic material constituted by semicrystalline polymers.
